(19) United States
(12) Patent Application Publication
(10) Pub. No.: US 2012/0021142 A1
(43) Pub. Date: Jan. 26, 2012

(54) ALIGNMENT LAYER COMPOSITION, ALIGNMENT LAYER PREPARED WITH THE SAME, PREPARATION METHOD OF ALIGNMENT LAYER, OPTICAL FILM CONTAINING THE SAME, AND DISPLAY DEVICE INCLUDING THE OPTICAL FILM

(76) Inventors: Dae-Hee Lee, Daejeon (KR); Moon-Soo Park, Daejeon (KR)

(21) Appl. No.: 13/259,946

(22) PCT Filed: Apr. 8, 2010
(86) PCT No.: PCT/KR2010/002173

§ 371 Date: Sep. 23, 2011

(30) Foreign Application Priority Data
Apr. 9, 2009 (KR) 10-2009-0030940
Apr. 2, 2010 (KR) 10-2009-0030369

(51) Int. Cl. G02F 1/1337; C09K 19/52; C09D 147/00; B05D 5/12

(52) U.S. Cl. 428/1.2; 427/58; 522/96; 522/39; 522/42; 522/44; 522/49; 522/64; 524/555

(57) ABSTRACT

The present invention relates to a liquid crystal alignment layer composition showing excellent adhesive strength to a substrate and a liquid crystal layer and excellent homeotropic alignment of liquid crystals, a liquid crystal alignment layer prepared with the same, a preparation method of the liquid crystal alignment layer, an optical film including the liquid crystal alignment layer, and a display device including the same. According to the present invention, provided are a liquid crystal alignment layer composition which comprises 1-50 wt % of a photocurable resin binder, 0.01-5 wt % of an amine compound selected from the group consisting of primary and secondary amino-based coupling agents, 0.1-5 wt % of a photoinitiator, and the remainder solvent; a method for preparing a liquid crystal alignment layer by coating the substrate with the liquid crystal alignment layer composition, removing the solvent, and curing the liquid crystal alignment layer composition; an alignment layer which is prepared with the liquid crystal alignment layer composition of the present invention; an optical film which comprises the substrate, the alignment layer, and a liquid crystal layer formed on the alignment layer; and a display device including the optical film. The liquid crystal alignment layer formed with the liquid crystal alignment layer composition of the present invention has excellent adhesive strength to the substrate and to an upper liquid crystal layer, and provides excellent homeotropic alignment to liquid crystals. The optical film of the present invention can be applied to a polarizer by itself and can be very helpfully used as a retardation film or a view angle compensation film in various types of LCD modes such as IPS mode and the like.

### TECHNICAL FIELD

This application claims the priority of Korean Patent Application Nos. 2009-30940 filed on Apr. 9, 2009 and 2010-30369 filed on Apr. 2, 2010 in the Korean Intellectual Property Office, the disclosures of which are incorporated herein by reference.

The present invention relates to an alignment layer composition, an alignment layer prepared with the same, a preparation method of the alignment layer, an optical film containing the alignment layer, and a display device including the optical film, and more particularly, to an alignment layer composition for homeotropic alignment liquid crystal showing excellent adhesive strength to a substrate and homeotropic alignment to liquid crystals, an alignment layer prepared with the same, a preparation method of the alignment layer, an optical film containing the alignment layer, and a display device including the optical film.

### BACKGROUND ART

In general, liquid crystals may be classified as a rod-type liquid crystal and a discotic-type liquid crystal having a coin shape when liquid crystals are classified according to shape. A material, in which at least two or more refractive indices differ from each other from among 3-dimensional refractive indices of nₓ, n_{y}, and n_{z} materials, is denoted as a birefringent material, and a direction, in which there is no generation of the phase difference of linearly polarized light in a direction of incident light, is defined as an optic axis. A major axis direction of molecules will be the optic axis in terms of the rod-type liquid crystal, and a minor axis direction of molecules will be the optic axis in terms of the discotic liquid crystal.

An alignment state of the rod-type liquid crystal may be largely classified as one of five types: First, a planar alignment in which an optic axis is parallel to a film plane; second, when the optic axis is perpendicular to the film plane, i.e., a homeotropic alignment that is parallel to a normal line of the film; third, a tilted alignment in which the optic axis is tilted at a certain angle between 0° and 90° with respect to the film plane; fourth, a splay alignment in which the optic axis varies continuously at a tilt angle from 0° to 90° or at the minimum value of a tilt angle in a range of 0° to 90°; and fifth, a cholesteric alignment, in which although the arrangement in which the optic axis is parallel to the film plane is similar to the planar alignment, the optic axis is rotates to a certain angle in a clockwise or anti-clockwise direction as it moves in a thickness direction when observed in a perpendicular direction with respect to the film plane.

The homeotropic alignment optical film among the foregoing five alignment types may be used as an optical film, such as a retardation film or a viewing angle compensation film, in liquid crystal display (LCD) modes such as a twist nematic (TN) mode, a super twist nematic (STN) mode, an in plane switching (IPS) mode, a vertical alignment (VA) mode, an optically compensated birefringence (OCB) mode alone or by being combined with other films. The homeotropic alignment optical film is generally prepared using a method of coating liquid crystals after forming a thin alignment layer with an aligning agent.

In order to adhere the homeotropic alignment optical film to a polarizing plate for the purpose of brightness enhancement or viewing angle compensation, a roll-to-roll process, in which compression is performed by passing the homeotropic alignment optical film and the polarizing plate between two rollers that face to each other and are spaced apart by a predetermined distance, similarly to a process of fabricating a polarizing plate, has to be performed, and a plastic substrate that is flexible when pressure or a small impact is applied thereto may be used for this purpose.

As related art for forming homeotropic alignment liquid crystals on a plastic film or an additional alignment layer, U.S. Pat. No. 6,816,218 describes using an aluminum layer deposited on a plastic substrate as a homeotropic alignment layer. However, a portion of aluminum may be removed during delamination because aluminum adheres weakly to a surface of the plastic substrate, and thus, it may be a cause of defects.

EP 1,376,163 A2 describes that a liquid crystal solution having planar or cholesteric alignment is coated on a plastic substrate, and then a homeotropic alignment liquid crystal is obtained thereon by using the coated liquid crystal solution as an alignment layer. However, there is a limitation in that the degree of homeotropic alignment of a liquid crystal layer is determined according to the degree of curing of liquid crystals used as an alignment layer.

Korean Patent Application No. 2005-0121835 discloses that a homeotropic alignment liquid crystal film is prepared by coating a polymerizable reactive liquid crystal mixture solution including a predetermined surfactant on a hydrophilic surface-treated plastic substrate without using a separate alignment layer for inducing a homeotropic alignment of liquid crystals.

However, there is a big limitation in the adhesion between liquid crystals and substrate, and liquid crystal alignment is fundamentally unstable, such that various defects are generated.

### DISCLOSURE

### Technical Problem

An aspect of the present invention provides a liquid crystal alignment layer composition providing excellent adhesion between a substrate and a liquid crystal layer.

Another aspect of the present invention provides a liquid crystal alignment layer composition providing excellent homeotropic alignment to liquid crystals.

Another aspect of the present invention provides a liquid crystal alignment layer having excellent adhesion between a substrate and a liquid crystal layer and homeotropic alignment to liquid crystals that uses the liquid crystal alignment layer composition of the present invention.

Another aspect of the present invention provides a method of preparing a liquid crystal alignment layer having excellent adhesion between a substrate and a liquid crystal layer and homeotropic alignment to liquid crystals that uses the liquid crystal alignment layer composition of the present invention.

Another aspect of the present invention provides an optical film including the liquid crystal alignment layer having excellent adhesion between a substrate and a liquid crystal layer and homeotropic alignment to liquid crystals according to the present invention.

Another aspect of the present invention provides a display device including the optical film.

### Technical Solution

According to an aspect of the present invention, there is provided a liquid crystal alignment layer composition comprising 1 wt % to 50 wt % of a photocurable resin binder, 0.01 wt % to 5 wt % of an amine compound selected from the group consisting of primary and secondary amino-based coupling agents, 0.1 wt % to 5 wt % of a photoinitiator, and a remainder solvent.

According to another aspect of the present invention, there is provided a liquid crystal alignment layer formed of the liquid crystal alignment layer composition according to the present invention.

According to another aspect of the present invention, there is provided a method for preparing a liquid crystal alignment layer including: coating a substrate with the liquid crystal alignment layer composition of the present invention; removing a solvent from the liquid crystal alignment layer composition; and curing the liquid crystal alignment layer composition in which solvent is removed therefrom.

According to another aspect of the present invention, there is provided an optical film including: a substrate; an alignment layer formed of the liquid crystal alignment layer composition of the present invention on the substrate; and a liquid crystal layer on the alignment layer.

According to another aspect of the present invention, there is provided a display device including the optical film according to the present invention.

### Advantageous Effects

A liquid crystal alignment layer formed of the liquid crystal alignment layer composition according to the present invention provides excellent adhesion to a substrate and excellent homeotropic alignment to liquid crystals. Also, the liquid crystal alignment layer of the present invention also has excellent adhesion to a liquid crystal layer on the liquid crystal alignment layer such that delamination of the liquid crystal layer formed on the alignment layer is prevented. An optical film including the alignment layer and the liquid crystal layer of the present invention may be applied to a polarizing plate by itself and may be very usefully used as a retardation film or a viewing angle compensation film in various types of LCD modes such as an IPS mode.

### DESCRIPTION OF DRAWINGS

The above and other aspects, features and other advantages of the present invention will be more clearly understood from the following detailed description taken in conjunction with the accompanying drawings, in which:

FIG. 1 is a side cross-sectional view illustrating a homeotropic alignment optical film (liquid crystal film) according to an embodiment of the present invention;

FIG. 2 is a graph showing a variation curve of a phase-difference value according to a viewing angle of a homeotropic alignment liquid crystal film according to Example 1;

FIG. 3 is a graph showing a variation curve of a phase-difference value according to a viewing angle of a homeotropic alignment liquid crystal film according to Example 2;

FIG. 4 is a graph showing a variation curve of a phase-difference value according to a viewing angle of a homeotropic alignment liquid crystal film according to Example 3;

FIG. 5 is a graph showing a variation curve of a phase-difference value according to a viewing angle of a homeotropic alignment liquid crystal film according to Example 4;

FIG. 6 is a graph showing a variation curve of a phase-difference value according to a viewing angle of a homeotropic alignment liquid crystal film according to Example 5;

FIG. 7 is a graph showing a variation curve of a phase-difference value according to a viewing angle of a homeotropic alignment liquid crystal film according to Example 6;

FIG. 8 is a graph showing a variation curve of a phase-difference value according to a viewing angle of a homeotropic alignment liquid crystal film according to Example 7;

FIG. 9 is a graph showing a variation curve of a phase-difference value according to a viewing angle of a homeotropic alignment liquid crystal film according to Example 8;

FIG. 10 is a graph showing a variation curve of a phase-difference value according to a viewing angle of a liquid crystal film according to Comparative Example 1; and

FIG. 11 is a graph showing a variation curve of a phase-difference value according to a viewing angle of a liquid crystal film according to Comparative Example 2.

### BEST MODE

Exemplary embodiments of the present invention will now be described in detail with reference to the accompanying drawings.

The present invention is provided for improving a liquid crystal alignment layer, and more particularly, for improving the adhesion between an alignment layer for a homeotropic alignment liquid crystal and a substrate or a liquid crystal layer and a homeotropic alignment of liquid crystals. The liquid crystal alignment layer composition according to the present invention including a curable resin binder and a primary and/or secondary amino-based coupling agent amine compound has excellent adhesion to the substrate and the liquid crystal layer as well as providing superior alignment with respect to a homeotropic alignment of liquid crystals.

1. Liquid Crystal Alignment Layer Composition

A liquid crystal alignment layer composition according to an embodiment of the present invention includes 1 wt % to 50 wt % of a photocurable resin binder, 0.01 wt % to 5 wt % of a primary and/or secondary amino-based coupling agent amine compound, 0.1 wt % to 5 wt % of photoinitiator, and a remainder solvent.

The photocurable resin binder is a main material of a liquid crystal alignment layer and any resin having excellent adhesion between a substrate and a liquid crystal layer and compatibility may be used therefor. Examples of the photocurable resin binder may be an acrylate- or methacrylate-based ultraviolet-curable monomer or oligomer. However, the photocurable resin binder is not limited thereto. A (meth)acrylate-based resin monomer and/or an oligomer having 1 to 15 functional groups may also be used alone or in a combination of two or more as the photocurable resin binder.

Examples of the (meth)acrylate-based monomer may be hydroxyethyl acrylate, hydroxypropyl acrylate, ethoxyethyl acrylate, ethyleneglycol dimethacrylate, diethyleneglycol dimethacrylate, polyethyleneglycol dimethacrylate, triethyleneglycol dimethacrylate, pentaerythritol acrylate, pentaerythritol diacrylate, pentaerythritol triacrylate, trimethylolpropane triacrylate, trimethylolpropane trimethacrylate, dipentacrythritol hexaacrylate, dipentacrythritol pentaacrylate, dipentaerythritol tetraacrylate, dipentaerythritol pentaacrylate. However, the (meth)acrylate-based monomer is not limited thereto.

Examples of the (meth)acrylate-based oligomer may be a urethane acrylate oligomer, an epoxy acrylate oligomer, polyether acrylate, or polyester acrylate. However, the (meth)acrylate-based oligomer is not limited thereto.

In the liquid crystal alignment layer composition of the present invention, when the photocurable resin binder is dissolved in a solvent, a concentration of the photocurable resin binder may be appropriately controlled according to the targeted thickness and coating method of the alignment layer generally known in the art. The photocurable resin binder may be combined in a range of 1 wt % to 50 wt %, and for example, in a range of 3 wt % to 15 wt % based on a total weight of the liquid crystal alignment layer composition of the present invention. However, the concentration of the photocurable resin binder is not limited thereto. When the content of the photocurable resin binder is less than 1 wt %, the drying time may be prolonged because the amount of the solvent is relatively large and severe stains may be obtained because of excessive surface flow after coating. When the content of the photocurable resin binder is more than 50 wt %, wetting may deteriorate during coating because viscosity is excessively high.

In order to improve the adhesion between the alignment layer and the substrate and/or the adhesion between the alignment and the liquid crystal layer formed on the alignment layer and homeotropic alignment of liquid crystals, at least one amine compound selected from the group consisting of primary and secondary amino-based coupling agent amine compounds is combined to the alignment layer composition. The amine compound may be used alone or together with two or more.

The primary amino-based coupling agent amine compound may be represented as the following Formula 1.

R¹—R²—NH₂ [Formula 1]

Where R¹ is selected from the group consisting of a C1-C20 alkyl group, a C3-C6 cycloalkyl, a C1-C19 alkyl amine group, —NBB″, and —RSi(R′)ₙ(OR″)₃₋ₙ, B and B″ may be the same or different from each other and are independently selected from H and C1-C8 alkyl group, respectively, R, R′, and R″ may be the same or different one another and are independently selected from a C1-C8 alkyl group, respectively, n is an integer between 0 and 2, R² is a simple bond or a C1-C20 alkanediyl group and one or two —CH₂— groups that are not adjacent to each other in the alkanediyl group may be displaced with at least one group selected from the group consisting of an —O—, an —NH—, a —CH═CH—, a —CONH—, and a C3-C8 cycloalkanediyl group.

Examples of the primary amino-based coupling agent amine compound may be methylamine, ethylamine, 1-propylamine, 2-propylamine, 1-butylamine(N-butyl amine), 2-butylamine, 3-(dimethylamino)propylamine, cyclopropylamine, cyclobutylamine, cyclopentylamine, cyclohexylamine, etc. However, the primary amino-based coupling agent amine compound is not limited thereto.

The secondary amino-based coupling agent amine compound may be represented as the following Formulas 2 to 5:

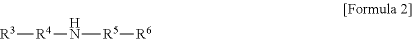

Where R³ and R⁶ may be the same or different from each other and are independently selected from the group consisting of a C1-C20 alkyl group, a C1-C19 alkyl amine group, an amine group, and —RSi(R′)ₙ(OR″)₃₋ₙ, R, R′, and R″ may be the same or different from one another and are independently selected from a C1-C8 alkyl group, respectively, n is an integer between 0 and 2, R⁴ and R⁵ may be the same or different from each other and are independently selected from the group consisting of a simple bond and a C1-C20 alkanediyl group, and one or two —CH₂— groups that are not adjacent to each other in the alkanediyl group may be displaced with at least one group selected from the group consisting of an —O—, an —NH—, a —CH═CH—, a —CONH—, and a C3-C8 cycloalkanediyl group.

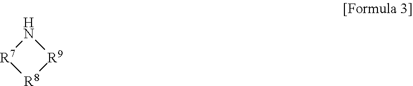

Where R⁷, R⁸, and R⁹ may be the same or different from one another and are independently selected from a substituted or unsubstituted C1-C20 alkanediyl group, respectively, one or two —CH₂— groups that are not adjacent to each other in the alkanediyl group may be displaced with at least one group selected from the group consisting of an —O—, an —NH—, a —CH═CH—, a —CONH—, and a C3-C8 cycloalkanediyl group, and a substituent may be —C═O when the C1-C20 alkanediyl group is substituted.

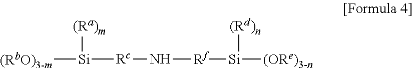

Where R^{a}, R^{b}, R^{d}, and R^{e} may be the same or different from one another and are independently selected from a C1-C8 alkyl group, respectively, R^{c} and R^{f} may be the same or different from each other and are independently selected from a C1-C20 alkanediyl group, respectively, one or two —CH₂— groups that are not adjacent to each other in the alkanediyl group may be displaced with at least one group selected from the group consisting of an —O—, an —NH—, a —CH═CH—, a —CONH—, and a C3-C8 cycloalkanediyl group, and n and m are independently integers between 0 and 2, respectively.

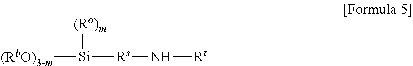

Where R^{q}, R^{r}, and R^{t} may be the same or different from one another and are independently selected from a C1-C8 alkyl group, respectively, R^{s} is a C1-C20 alkanediyl group, one or two —CH₂— groups that are not adjacent to each other in the alkanediyl group may be displaced with at least one group selected from the group consisting of an —O—, an —NH—, a —CH═CH—, a —CONH—, and a C3-C8 cycloalkanediyl group, and m is an integer between 0 and 2.

Also, the phrase “one or two —CH₂— groups that are not adjacent to each other in the alkanediyl group are displaced with an —O—, an —NH—, a —CH═CH—, a —CONH—, or a C3-C8 cycloalkanediyl group” denotes that —CH₂— groups itself that are not adjacent to each other in the alkanediyl group are displaced with “an —O—, an —NH—, a —CH═CH—, a —CONH—, or a C3-C8 cycloalkanediyl group”. As an example for understanding, the phrase means that the alkanediyl group may exist as a formula such as —CH₂—NH—CH₂— or CH═CH—CH₂— in Formulas, although is it not limited thereto. The phrase ‘simple bond’ denotes that a group and/or an element at both sides of the simple bond are directly bonded without passing through other groups and/or elements.

Specific examples of the secondary amino-based coupling agent may be dimethylamine, diethylamine, dipropylamine, dibutylamine, azetidine, pyrrolidine, piperidine, 2-azetidinone, 2-pyrrolidinone, 2-piperidinone, etc. However, the secondary amino-based coupling agent is not limited thereto.

Additional examples of the secondary amino-based coupling agent may be bis(3-trimethoxy silylpropyl)amine, bis(3-triethoxy silylpropyl)amine, N-(n-butyl)-3-amino propyl trimethoxy silane, N-(n-butyl)-3-amino propyl triethoxy silane, N-methyl amino propyl trimethoxy silane, N-methyl amino propyl triethoxy silane, etc. However, the secondary amino-based coupling agent is not limited thereto.

For example, the primary or the secondary amino-based coupling agent amine compound may be represented as the following Formulas 6-1 to 6-4.

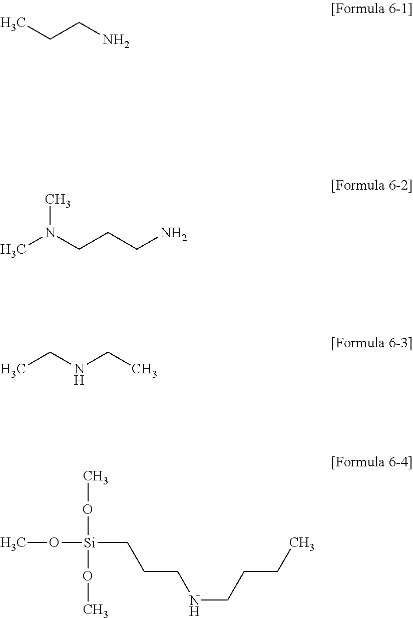

The primary and/or the secondary amino-based coupling agent combined with the liquid crystal alignment layer composition of the present invention may be combined in a range of 0.01 wt % to 5 wt % based on a weight of the liquid crystal alignment layer composition. When the content of the amino-based coupling agent is less than 0.01 wt %, the adhesion between the alignment layer and the substrate and/or the adhesion between the alignment layer and liquid crystal layer is poor, and when the content of the amino-based coupling agent is more than 5 wt %, scratch resistance of the alignment layer decreases.

Any photoinitiator known in the art may be used as long as it has no limitation in compatibility with the photocurable resin binder and the amino-based coupling agent.

Examples of the photoinitiator may be 2-methyl-1-[4-(methylthio)phenyl]-2-(4-morpholinyl)-1-propranone (Irgacure 907™ of Ciba-Geigy AG may be used), 2-dimethoxy-1,2-diphenylethan-1-one (Irgacure 651™ of Ciba-Geigy AG may be used), 1-hydroxy-cyclohexyl-phenyl-ketone (Irgacure 184™ of Ciba-Geigy AG may be used), triaryl sulfonium hexafluoroantimonate salts (UVI6974™ of Union Carbide Corporation may be used), or diphenyl(2,4,6-trimethylbenzoyl)-phosphine oxide (Darocur TPO™ of Ciba-Geigy AG may be used). However, the photoinitiator is not limited thereto.

A content of the photoinitiator may be in a range of 0.1 wt % to 5 wt % based on a total weight of the liquid crystal alignment layer composition. When the content of the photoinitiator is less than 0.1 wt %, an uncured alignment layer is generated, and durability will be poor when the content of the photoinitiator is more than 5 wt %.

A solvent type is not particularly limited, as long as it has excellent solution stability of the liquid crystal alignment layer composition, excellent adhesion between the substrate and the liquid crystal layer and does not corrode the substrate, and any solvent generally known in the art may be used.

Examples of the solvent usable in the liquid crystal alignment layer composition of the present invention may be halogenated hydrocarbons such as chloroform, dichloromethane, tetrachloroethane, trichloroethylene, tetrachloroethylene, or chlorobenzene; aromatic hydrocarbons such as benzene, toluene, xylene, methoxybenzene, or 1,2-dimethoxybenzene; alcohols such as methanol, ethanol, propanol, isopropanol, acetone, methylethylketone, methylisobutylketone, cyclohexanone, or cyclopentanone; cellosolves such as methyl cellosolve, ethyl cellosolve, or butyl cellosolve; ethers such as diethylene glycol dimethyl ether (DEGDME) or dipropylene glycol dimethyl ether (DPGDME). However, the solvent usable in the liquid crystal alignment layer composition is not limited thereto. The solvent may be used alone or as a mixture of two or more kinds thereof.

In the alignment layer composition according to an embodiment of the present invention, additives such as an antioxidant, a leveling agent, or a surfactant, which may be generally combined in the alignment layer composition in the art, may be added optionally if required in an amount range that is generally combined in the art.

2. Method of Preparing Alignment Layer and Alignment Layer Prepared Thereby

A liquid crystal alignment layer composition according to an embodiment of the present invention is coated and dried on a substrate, and then cured such that a liquid crystal alignment layer, particularly an alignment layer for a homeotropic alignment liquid crystal may be prepared.

Although a thickness of the liquid crystal alignment layer is in a range generally known in the art and is not particularly limited, the liquid crystal alignment layer may be formed to have a thickness range from about 0.01 μm to about 10 μm. Physical properties such as desired homeotropic liquid crystal alignment may be sufficiently obtained in the foregoing thickness range.

A plastic substrate generally known in the art, which has excellent adhesion to the liquid crystal alignment layer composition according to the present invention, may be used as a substrate. Examples of the usable substrate may be a cyclo-olefin polymer substrate such as triacetyl cellulose, polyacrylate, polyethylene terephthalate, polycarbonate, polyethylene, or a norbornene derivative. However, the plastic substrate is not limited thereto. The plastic substrate also has excellent flexibility and durability and may be suitable for mass production such as roll-to-roll production or high-speed production. Also, the plastic substrate applicable to roll-to-roll processing may be subjected to a corona discharge treatment or a plasma treatment to allow a surface of the substrate to have hydrophilicity.

First, the liquid crystal alignment layer composition according to the present invention is coated on the foregoing substrate. A coating method is not particularly limited, but coating may be performed by a method capable of conformally coating (such as uniform thickness) the liquid crystal alignment layer composition on the substrate. The coating method usable during the formation of the alignment layer of the present invention may be spin coating, micro gravure coating, gravure coating, dip coating, or spray coating, and the coating method is not limited thereto.

The liquid crystal alignment layer composition is coated on the substrate, and then dried to remove the solvent. Solvent removal may be performed by any method generally known in the art that may remove most of the solvent and does not allow the coated alignment layer to flow or move significantly. The solvent removal is not particularly limited, and for example, may be performed by room temperature drying, drying in a drying oven, heat drying on a heating plate, drying using infrared radiation, etc.

The drying time and drying temperature vary, according to the type and content of the solvent and are not particularly limited. The drying may be performed in any range that may remove the solvent without adversely affecting the physical properties of the alignment layer. The drying may be performed for sufficient time to remove the solvent at a temperature range of 50° C. to 100° C., and for example, may be preformed within a range of about 30 seconds to about 300 seconds. When the drying is performed in the foregoing temperature range and for a period of time within the foregoing time range, the solvent may be effectively removed without adversely affecting physical properties of the alignment layer and components of the alignment layer.

The coated alignment layer with the solvent removed is cured to prepare the alignment layer. Curing is broadly classified as photocuring and heat curing. The polymerizable reactive liquid crystal alignment layer composition of the present invention is a photoreactive mixture which is a material fixed by ultraviolet irradiation. Therefore, the coated alignment layer may be photocured in a method of preparing the alignment layer according to another embodiment of the present invention. A photocurable resin binder is polymerized by curing, such that a solid liquid crystal alignment layer is formed. The curing is performed under the presence of the photoinitiator, absorbing wavelengths of an ultraviolet range. Meanwhile, ultraviolet irradiation may be performed in an air or in a nitrogen atmosphere in order to increase reaction efficiency by blocking oxygen. A medium- or high-pressure mercury ultraviolet lamp generally having a luminance of about 100 mW/cm² or more, or a metal halide lamp, may be used as an ultraviolet irradiator. However, the ultraviolet irradiator is not limited thereto. Further, a cold mirror or a cooling device may be installed between the substrate and the ultraviolet lamp (irradiator) in order to prevent deformation of a film by maintaining the surface temperature of the film at an appropriate level during ultraviolet irradiation.

The liquid crystal alignment layer, particularly the alignment layer for homeotropic alignment liquid crystal, is obtained by coating, drying, and curing the liquid crystal alignment layer composition according to an embodiment of the present invention on the substrate. Thus, the liquid crystal alignment layer formed of the liquid crystal alignment layer composition including the amine compound selected from the primary and/or secondary amino-based coupling agents of the present invention has excellent adhesion to the liquid crystal layer formed on the alignment layer and the substrate, and the delamination of the alignment layer from the substrate during processing is prevented. Also, since the liquid crystal alignment layer of the present invention has excellent alignment with respect to a homeotropic alignment of liquid crystals, blurs due to the poor alignment of liquid crystals are also prevented. Therefore, the liquid crystal layer formed on the foregoing alignment layer is appropriate to be used as an optical film.

3. Method of Preparing Optical Film and Optical Film

A liquid crystal layer is formed by coating, drying, and curing a polymerizable reactive homeotropic alignment liquid crystal mixture solution (hereinafter, referred to as the ‘liquid crystal solution’) on the alignment layer according to an embodiment of the present invention.

The liquid crystal solution may be formed of a polymerizable reactive homeotropic alignment liquid crystal composition including 5 wt % to 70 wt % of a reactive liquid crystal monomer, 0.05 wt % to 1 wt % of a surfactant, 1 wt % to 10 wt % of a photoinitiator, and a remainder solvent.

Any reactive liquid crystal monomer generally known in the art may be used as long as it forms a polymer through polymerization with adjacent liquid crystal monomers by light or heat. A liquid crystal monomer with an acrylate attached thereto may be used as an example of a reactive group which generates a polymerization reaction of the reactive liquid crystal monomer. Examples of the reactive liquid crystal monomer may be one or more selected from the group consisting of reactive liquid crystal monomers represented in the following Formulas 7 to 11. However, the reactive liquid crystal monomer is not limited thereto.

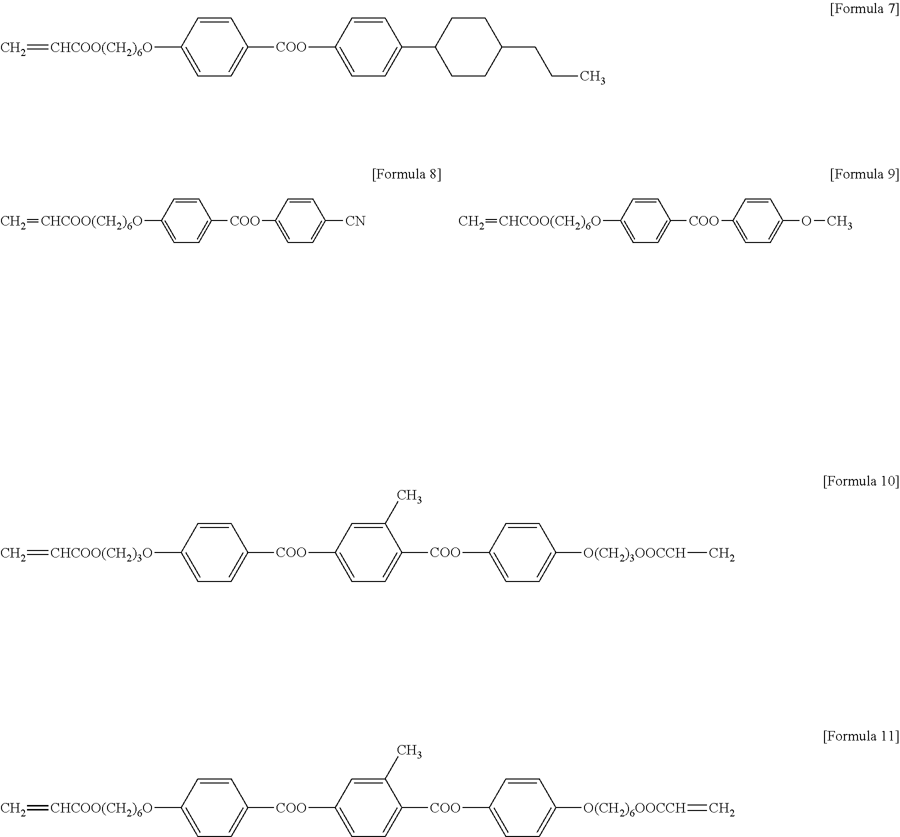

A content of the reactive liquid crystal monomer in the liquid crystal solution may vary according to the targeted thickness and coating method of the liquid crystal layer. Although the content of the reactive liquid crystal monomer is not particularly limited, the content of the reactive liquid crystal monomer may be in a range of 5 wt % to 70 wt %, and for example, in a range of 10 wt % to 50 wt % based on a weight of the liquid crystal solution. When the content of the liquid crystal monomer is less than 5 wt %, the drying time may be prolonged because the amount of the solvent is large or severe stains may be obtained because of excessive surface flow after coating. When the content of the liquid crystal monomer is more than 70 wt %, liquid crystals may be precipitated during storage due to a low solvent content in comparison to a solid content or wetting may deteriorate during coating because viscosity is excessively high.

Although the surfactant is not particularly limited, fluorocarbon- and silicon-based surfactants, for example, may be used. Examples of the fluorocarbon-based surfactant may be 3M products such as Fluorad FC4430™, Fluorad FC4432™, or Fluorad FC4434™, or a Dupont product such as Zonyl, etc. However, the fluorocarbon-based surfactant is not limited thereto. Examples of the silicon-based surfactant may be BYK-Chemie GmbH products such as the BYK™ series, etc. However, the silicon-based surfactant is not limited thereto. A content of the surfactant may be in a range of 0.05 wt % to 1 wt %, based on a weight of the polymerizable reactive homeotropic alignment liquid crystal composition. When the content of the surfactant is less than 0.05 wt %, the state of a liquid crystal surface is poor, and when the content of the surfactant is more than 1 wt %, stains may be generated because micelles of the surfactant are generated due to a large input amount of the surfactant.

The photoinitiator is broadly classified as a free radical photoinitiator and a photoinitiator that generates ions according to the type of a material initiating a polymerization reaction. Examples of the free radical photoinitiator may be 2-methyl-1-[4-(methylthio)phenyl]-2-(4-morpholinyl)-1-propanone (Ciba-Geigy AG Irgacure 907™, may be used), 2-dimethoxy-1,2-diphenylethan-1-one (Ciba-Geigy AG Irgacure 651™ may be used), 1-hydroxy-cyclohexyl-phenyl-ketone (Ciba-Geigy AG Irgacure 184™ may be used), etc. However, the free radical photoinitiator is not limited thereto. Triaryl sulfonium hexafluoroantimonate salts (Union Carbide Corporation UVI 6974™ may be used) may be used as a cationic photopolymerization initiator which is a type of the photoinitiator that generates ions. However, the cationic photopolymerization initiator is not limited thereto.

A content of the photoinitiator may be in a range of 1 wt % to 10 wt % based on a weight of the polymerizable reactive homeotropic alignment liquid crystal mixture solution (liquid crystal solution). When the content of the photoinitiator is less than 1 wt %, uncured liquid crystals may be generated, and liquid crystal alignment will be poor when the content of the photoinitiator is more than 10 wt %.

Any solvent generally known in the art may be used in the liquid crystal solution as long as it has excellent solubility and coatability of the components included in the liquid crystal composition and does not corrode the alignment layer during coating thereon. Examples of the solvent may be halogenated hydrocarbons such as chloroform, dichloromethane, tetrachloroethane, trichloroethylene, tetrachloroethylene, or chlorobenzene; aromatic hydrocarbons such as benzene, toluene, xylene, methoxybenzene, or 1,2-dimethoxybenzene; alcohols such as methanol, ethanol, propanol, isopropanol, acetone, methylethylketone, methylisobutylketone, cyclohexanone, or cyclopentanone; cellosolves such as methyl cellosolve, ethyl cellosolve, or butyl cellosolve; ethers such as diethylene glycol dimethyl ether (DEGDME) or dipropylene glycol dimethyl ether (DPGDME). However, the solvent is not limited thereto. The solvent may be used alone or as a mixture of two or more kinds thereof.

The foregoing reactive liquid crystal solution is coated on the alignment layer and the solvent is removed, and then a homeotropically aligned liquid crystal layer is formed by curing the liquid crystal layer. The reactive liquid crystal solution for describing the present invention and the liquid crystal layer of the optical film according to an embodiment of the present embodiment is not limited to the foregoing reactive liquid crystal solution. Any composition for forming a liquid crystal layer generally known in the art may be applied to form a liquid crystal layer on the alignment layer according to the present invention.

First, a reactive liquid crystal solution is coated on the alignment layer according to an embodiment of the present invention. A coating method is not particularly limited, but coating may be performed by a method capable of conformally coating (such as uniform thickness) the liquid crystal alignment layer composition on the substrate. The coating method usable in the formation of the liquid crystal layer of the present invention may be spin coating, micro gravure coating, gravure coating, dip coating, or spray coating, but the coating method is not limited thereto.

A thickness of the homeotropic alignment liquid crystal layer varies according to a targeted phase difference, i.e., Δn (birefringence)×d (thickness of liquid crystal film), but the thickness of the homeotropic alignment liquid crystal layer is generally in a range of 0.1 μm and to 10 μm. The liquid crystal layer may be in a thickness range of 0.1 μm to 10 μm in order to obtain a proper range of the phase difference for the optical compensation of a liquid crystal display (LCD) device.

The liquid crystal solution is coated on the substrate, and then dried to remove the solvent. Solvent removal may be performed by any method generally known in the art that may remove most of the solvent and does not allow the coated liquid crystal layer to flow or severely move. The solvent removal is not particularly limited, and for example, may be performed by room temperature drying, drying in a drying oven, heat drying on a heating plate, drying using infrared radiation, etc. The drying time and drying temperature vary according to the type and content of the solvent and are not particularly limited. The drying may be performed in any condition such as temperature and time range that may remove the solvent without adversely affecting physical properties of the liquid crystal layer. The drying may be performed for sufficient time to remove the solvent at a temperature range of 50° C. to 100° C., and for example, may be performed within a range of about 30 seconds to about 300 seconds. When the drying is performed at the foregoing temperature range for the foregoing time range, the solvent may be effectively removed without adversely affecting physical properties of the liquid crystal layer and components of the liquid crystal layer.

The solvent is removed by evaporation, and then the homeotropically aligned liquid crystal layer is cured by polymerization. A method of curing liquid crystals is broadly classified as photocuring and heat curing. The liquid crystal solution is a photoreactive liquid crystal solution which is a material fixed by ultraviolet irradiation. Therefore, the liquid crystal layer may be fixed through curing by means of photocuring. A homeotrpically aligned liquid crystal material is polymerized by curing and the homeotropic alignment is fixed. The curing may be performed under the presence of the photoinitator absorbing wavelengths of an ultraviolet range. Meanwhile, ultraviolet irradiation may be performed in the air or in a nitrogen atmosphere in order to increase reaction efficiency by blocking oxygen. A medium- or high-pressure mercury ultraviolet lamp generally having a luminance of about 100 mW/cm² or more, or a metal halide lamp may be used as an ultraviolet irradiator. However, the ultraviolet irradiator is not limited thereto. Further, a cold mirror or a cooling device may be installed between the substrate and the ultraviolet lamp (irradiator) in order to prevent deformation of a film by maintaining the surface temperature of the film at an appropriate level during ultraviolet irradiation.

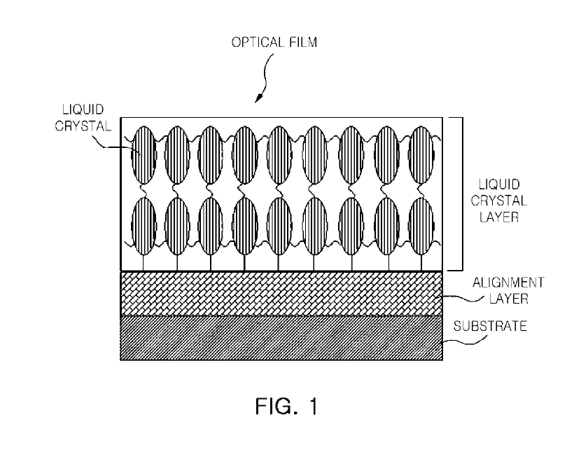

The homeotropic alignment liquid crystal layer is formed on the liquid crystal alignment layer formed of the liquid crystal alignment layer composition according to an embodiment of the present invention such that an optical film including the substrate, the liquid crystal alignment layer on the substrate, and the liquid crystal layer on the liquid crystal alignment layer, particularly a liquid crystal film, is obtained, and a side cross-sectional view of the foregoing optical film is shown in FIG. 1. The liquid crystal alignment layer according to an embodiment of the present invention has excellent alignment with respect to the homeotropic alignment of liquid crystals in the liquid crystal layer and the liquid crystal layer formed on the alignment layer is not delaminated because the adhesion between the alignment layer and the substrate and the adhesion between the alignment layer and the liquid crystal layer are excellent as well as having stable alignment characteristics. Also, the optical film including the alignment layer and the liquid crystal layer of the present invention may be applied to a polarizing plate by itself and may be very usefully used as a retardation film or a viewing angle compensation film in various types of LCD modes such as an IPS mode. According to the present invention, a display device including the optical film (liquid crystal film) of the present invention is also provided.

While the present invention has been shown and described in connection with the exemplary embodiments, it will be apparent to those skilled in the art that modifications and variations can be made without departing from the spirit and scope of the invention as defined by the appended claims.

### MODE FOR INVENTION

Hereinafter, the present invention will be described in detail with reference to Examples. The following Examples only illustrate the present invention and the scope of the present invention is not limited thereto.

### Preparation Example 1 of Alignment Layer Composition

Each component used in a conductive alignment layer composition for a homeotropic alignment optical film was mixed at the composition ratio shown in Table 1.

TABLE 1

| Component | Composition ratio (wt %) |
|---|---|
| Pentaerythritol acrylate⁽¹⁾ | 57.6 |
| Urethane acrylate oligomer⁽²⁾ | 38.4 |
| BHT⁽³⁾ | 0.1 |
| Irgacure184 ™⁽⁴⁾ | 3.9 |

⁽¹⁾Pentaerythritol acrylate: SR444D ™ from Sartomer Co. Inc.,
⁽²⁾Urethane acrylate oligomer: SC2100 ™ from Miwon Commercial Co., Ltd.,
⁽³⁾BHT (Butylated hydroxytoluene): Antioxidant from Sigma-Aldrich
⁽⁴⁾Irgacure 184 ™: Photoinitiator from Ciba-Geigy

The mixture was diluted with a mixed solvent with 40 wt % of ethanol, 30 wt % of 1-propanol, and 30 wt % of methyl ethyl ketone to have a concentration of 10 wt % based on 100 wt % of the total solution. Finally, an amino-based coupling agent (1-propylamine) represented by the Formula 6-1 was added to have a concentration of 0.1 wt % based on the mixture solution. The solution was uniformly stirred for 1 hr to prepare a polymerizable resin composition for an alignment layer for a homeotropic alignment liquid crystal film.

### Preparation Example 2 of Alignment Layer Composition

An alignment composition (solution) was prepared in the same manner as in Preparation Example 1 of the alignment layer composition, except that 3-(dimethyl amino)propyl represented by Formula 6-2 was used as an amino-based coupling agent in an amount of 1 wt %.

### Preparation Example 3 of Alignment Layer Composition

An alignment composition (solution) was prepared in the same manner as in Preparation Example 1 of the alignment layer composition, except that diethyl amine represented by Formula 6-3 was used as an amino-based coupling agent in an amount of 3 wt %.

### Preparation Example 4 of Alignment Layer Composition

An alignment composition (solution) was prepared in the same manner as in Preparation Example 1 of the alignment layer composition, except that N-(n-butyl)-3-aminopropyltrimethoxysilane represented by Formula 6-4 was used as an amino-based coupling agent in an amount of 4 wt %.

### Preparation Example 5 of Alignment Layer Composition

An alignment composition (solution) was prepared in the same manner as in Preparation Example 1 of the alignment layer composition, except that cyclohexylamine was used as an amino-based coupling agent in an amount of 0.5 wt %.

### Preparation Example 6 of Alignment Layer Composition

An alignment composition (solution) was prepared in the same manner as in Preparation Example 1 of the alignment layer composition, except that piperidine was used as an amino-based coupling agent in an amount of 3 wt %.

### Preparation Example 7 of Alignment Layer Composition

An alignment composition (solution) was prepared in the same manner as in Preparation Example 1 of the alignment layer composition, except that 2-pyrrolidinone was used as an amino-based coupling agent in an amount of 4 wt %.

### Preparation Example 8 of Alignment Layer Composition

An alignment composition (solution) was prepared in the same manner as in Preparation Example 1 of the alignment layer composition, except that bis(3-triethoxysilylpropyl)amine was used as an amino-based coupling agent in an amount of 5 wt %.

### Preparation Example 1 of Liquid Crystal Solution

Each component constituting a polymerizable reactive homeotropic alignment liquid crystal mixture was mixed at the composition ratio shown in Table 2 to prepare the mixture.

TABLE 2

| Component | | Composition ratio (wt %) |
|---|---|---|
| Liquid crystal | Formula 7 | 30.8 |
| monomer | Formula 8 | 21.8 |
| | Formula 9 | 21.8 |
| | Formula 10 | 20.1 |
| Photoinitiator | Irgacure 907 ™⁽¹⁾ | 5.5 |

⁽¹⁾Irgacure 907 ™: Photoinitiator from Ciba-Geigy

The constituting component mixture of the polymerizable reactive homeotropic alignment liquid crystal solution in Table 2 was added to toluene to have a solid concentration of 25 wt %, and BYK333™, a product from BYK-Chemie, was added to be present in an amount of 0.3 wt % based on the total weight of the liquid crystal mixture solution. Subsequently, the solution was heated at 50° C. for 1 hr while being stirred to prepare a polymerizable reactive liquid crystal mixture solution.

### Preparation Example 2 of Liquid Crystal Solution

Each component constituting a polymerizable reactive homeotropic alignment liquid crystal mixture was mixed at the composition ratio shown in Table 3 to prepare the mixture.

TABLE 3

| Component | | Composition ratio (wt %) |
|---|---|---|
| Liquid crystal | Formula 7 | 30.8 |
| monomer | Formula 8 | 21.8 |
| | Formula 10 | 21.8 |
| | Formula 11 | 20.1 |
| Photoinitiator | Irgacure 907 ™⁽¹⁾ | 5.5 |

⁽¹⁾Irgacure 907 ™: Photoinitiator from Ciba-Geigy

A liquid crystal solution was manufactured in the same manner as in Preparation Example 1, except that the constituting component mixture of the polymerizable reactive homeotropic alignment liquid solution shown in Table 3 was used.

### Example 1

### Preparation of Optical Film

Zeonor™ (manufactured by Japan Zeon Co., Ltd.), which is a norbornene derivative film as a substrate for coating a conductive alignment layer for a homeotropic alignment optical film, was subjected to corona discharge treatment and used.

The polymerizable resin composition for a homeotropic alignment optical film (alignment layer composition) prepared in Preparation Example 1 was coated on the substrate by using a wire bar coater, allowed to rest at 70° C. in a drying oven for 2 min, and cured at a rate of 3 m/min by using a 80 W/cm² high pressure mercury vapor lamp. An alignment layer produced was very transparent, showed excellent adhesive strength to a substrate and had a thickness of about 0.3 μm.

The polymerizable reactive liquid crystal solution prepared in Preparation Example 1 of a Crystal Solution was coated on the alignment layer formed by using a wire bar coater, allowed to rest at 70° C. in a drying oven for 2 min, and cured at a rate of 3 m/min by using a 80 W/cm² high pressure mercury vapor lamp. A liquid crystal layer produced was very transparent and had a thickness of about 1.2 μm. An optical film (liquid crystal film) including the alignment layer and the liquid crystal layer, prepared in the present Example, has a structure shown in FIG. 1.

In the present Example, the following other Examples, and Comparative Examples, the adhesion was evaluated by a Cross Cut Cellotape Peeling Test. That is, a 100-cell lattice with a cell gap of 1 mm in both longitudinal and lateral directions was formed with a knife on the liquid crystal layer plane of the optical film, and then a process of attaching and detaching cellotape thereto/therefrom was performed to observe whether the lattice peeled off. The optical film in the present Example 1 has excellent adhesive strength between the alignment layer and the liquid crystal layer, and thus the liquid crystal layer lattice was not peeled off from the substrate at all.

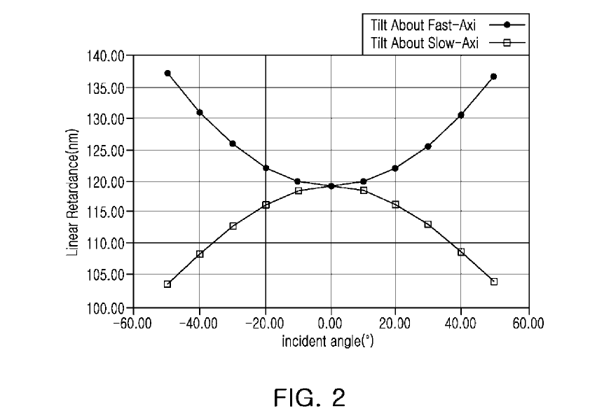

In addition, in order to investigate optical properties of the optical films prepared in Examples and Comparative Examples, the phase difference of the optical film adhered on the substrate was measured by using an AxoScan (manufactured by Axometrics, Inc.). The result of the optical film in Example 1 is shown in FIG. 2. According to FIG. 2, a phase difference was not generated by the liquid crystal in the vertical direction of the film and as the view angle increased, the phase difference increased and both − and + directions of the view angle are symmetric with each other. Therefore, it was identified that liquid crystal molecules in the optical film were homeotropically aligned to the film plane of the optical film. In addition, defects such as blurs due to the alignment of the liquid crystals and the like were not observed from the optical film prepared in the present Example.

### Example 2

### Preparation of Optical Film

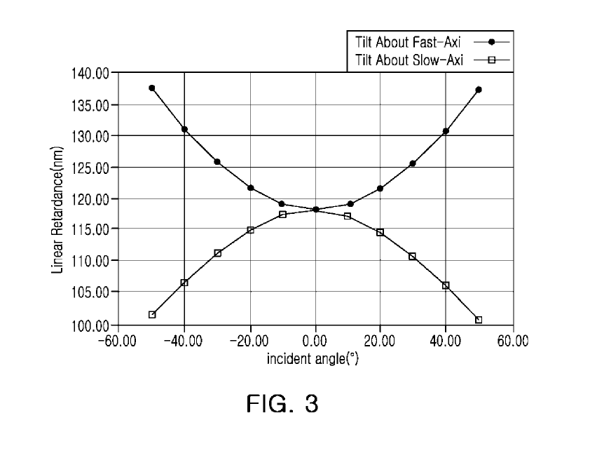

An optical film was obtained in the same manner as in Example 1, except that the alignment layer composition of Preparation Example 2 of Alignment Layer Composition was used, and the alignment layer and liquid crystal layer produced were very transparent and had thicknesses of about 0.3 μm and about 1.2 μm, respectively. The optical film prepared in Example 2 had excellent adhesive strength between the alignment layer and the liquid crystal layer, and thus the liquid crystal layer was not peeled off from the substrate at all. As shown in FIG. 3, a phase difference was not generated by the liquid crystal in the vertical direction of the film and as the view angle increased, the phase difference increased and both − and + directions of the view angle are symmetric with each other. Therefore, it was identified that liquid crystal molecules in the optical film were homeotropically aligned to the film plane of the optical film. In addition, defects such as blurs due to the alignment of the liquid crystals and the like were not observed from the optical film prepared in the present Example.

### Example 3

### Preparation of Optical Film

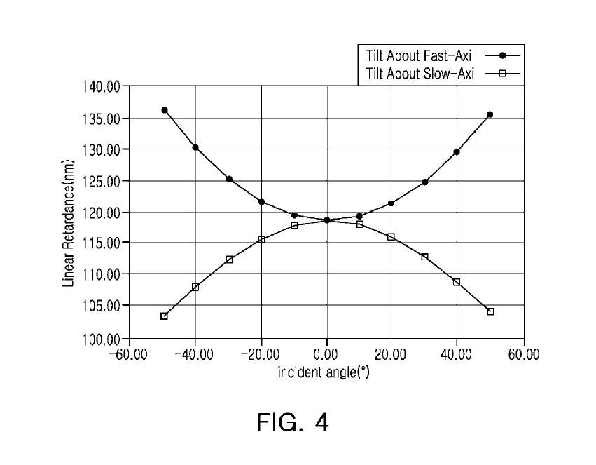

An optical film was obtained in the same manner as in Example 1, except that the alignment layer composition of Preparation Example 3 of Alignment Layer Composition was used, and the alignment layer and liquid crystal layer produced were very transparent and had thicknesses of about 0.3 μm and about 1.2 μm, respectively. The optical film prepared in Example 3 had excellent adhesive strength between the alignment layer and the liquid crystal layer, and thus the liquid crystal layer was not peeled off from the substrate at all. As shown in FIG. 4, a phase difference was not generated by the liquid crystal in the vertical direction of the film and as the view angle increased, the phase difference increased and thus both − and + directions of the view angle are symmetric with each other. Therefore, it was identified that liquid crystal molecules in the optical film were homeotropically aligned to the film plane of the optical film. In addition, defects such as blurs due to the alignment of the liquid crystals and the like were not observed from the optical film prepared in the present Example.

### Example 4

### Preparation of Optical Film

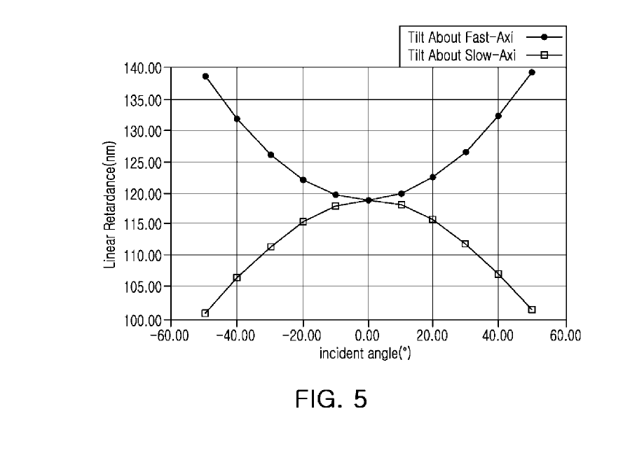

An optical film was obtained in the same manner as in Example 1, except that the alignment layer composition of Preparation Example 4 of Alignment Layer Composition was used, and the alignment layer and liquid crystal layer produced were very transparent and had thicknesses of about 0.3 μm and about 1.2 μm, respectively. The optical film prepared in Example 4 had excellent adhesive strength between the alignment layer and the liquid crystal layer, and thus the liquid crystal layer was not peeled off from the substrate at all. As shown in FIG. 5, a phase difference was not generated by the liquid crystal in the vertical direction of the film and as the viewing angle increased, the phase difference increased and thus both − and + directions of the view angle are symmetric with each other. Therefore, it was identified that liquid crystal molecules in the optical film were homeotropically aligned to the film plane of the optical film. In addition, defects such as blurs due to the alignment of the liquid crystals and the like were not observed from the optical film prepared in the present Example.

### Example 5

### Preparation of Optical Film

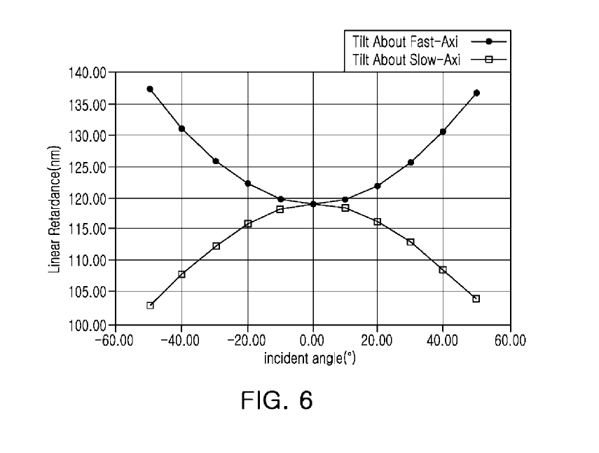

An optical film was obtained in the same manner as in Example 1, except that the alignment layer composition of Preparation Example 5 and the liquid crystal solution in Preparation Example 2 were used, and the alignment layer and liquid crystal layer produced were very transparent and had thicknesses of about 0.3 μm and about 1.2 μm, respectively. The optical film prepared in Example 5 had excellent adhesive strength between the alignment layer and the liquid crystal layer, and thus the liquid crystal layer was not peeled off from the substrate at all. As shown in FIG. 6, a phase difference was not generated by the liquid crystal in the vertical direction of the film and as the view angle increased, the phase difference increased and thus both − and + directions of the view angle are symmetric with each other. Therefore, it was identified that liquid crystal molecules in the optical film were homeotropically aligned to the film plane of the optical film. In addition, defects such as blurs due to the alignment of the liquid crystals and the like were not observed from the optical film prepared in the present Example.

### Example 6

### Preparation of Optical Film

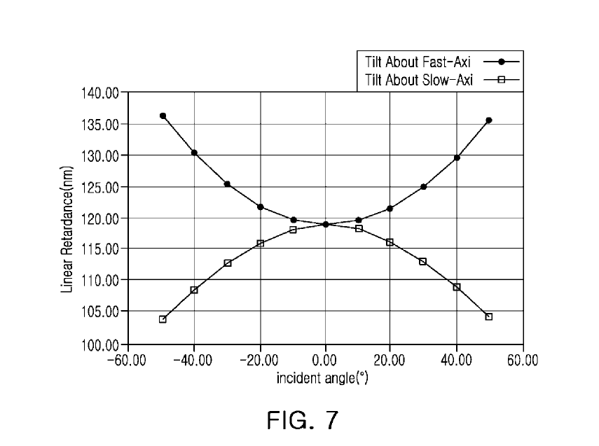

An optical film was obtained in the same manner as in Example 5, except that the alignment layer composition of Preparation Example 6 was used, and the alignment layer and liquid crystal layer produced were very transparent and had thicknesses of about 0.3 μm and about 1.2 μm, respectively. The optical film prepared in Example 6 had excellent adhesive strength between the alignment layer and the liquid crystal layer, and thus the liquid crystal layer was not peeled off from the substrate at all. As shown in FIG. 7, a phase difference was not generated by the liquid crystal in the vertical direction of the film and as the viewing angle increased, the phase difference increased and thus both − and + directions of the view angle are symmetric with each other. Therefore, it was identified that liquid crystal molecules in the optical film were homeotropically aligned to the film plane of the optical film. In addition, defects such as blurs due to the alignment of the liquid crystals and the like were not observed from the optical film prepared in the present Example.

### Example 7

### Preparation of Optical Film

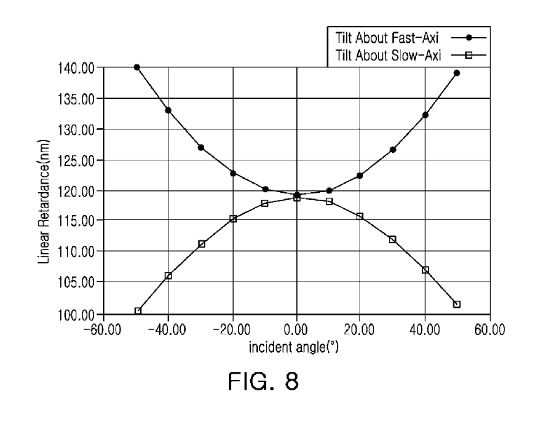

An optical film was obtained in the same manner as in Example 5, except that the alignment layer composition of Preparation Example 7 was used, and the alignment layer and liquid crystal layer produced were very transparent and had thicknesses of about 0.3 μm and about 1.2 μm, respectively. The optical film prepared in Example 7 had excellent adhesive strength between the alignment layer and the liquid crystal layer, and thus the liquid crystal layer was not peeled off from the substrate at all. As shown in FIG. 8, a phase difference was not generated by the liquid crystal in the vertical direction of the film and as the view angle increased, the phase difference increased and thus both − and + directions of the view angle are symmetric with each other. Therefore, it was identified that liquid crystal molecules in the optical film were homeotropically aligned to the film plane of the optical film. In addition, defects such as blurs due to the alignment of the liquid crystals and the like were not observed from the optical film prepared in the present Example.

### Example 8

### Preparation of Optical Film

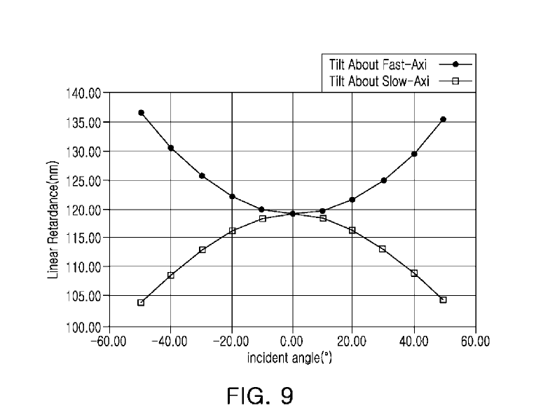

An optical film was obtained in the same manner as in Example 5, except that the alignment layer composition of Preparation Example 8 was used, and the alignment layer and liquid crystal layer produced were very transparent and had thicknesses of about 0.3 μm and about 1.2 μm, respectively. The optical film prepared in Example 8 had excellent adhesive strength between the alignment layer and the liquid crystal layer, and thus the liquid crystal layer was not peeled off from the substrate at all. As shown in FIG. 9, a phase difference was not generated by the liquid crystal in the vertical direction of the film and as the view angle increased, the phase difference increased and thus both − and + directions of the view angle are symmetric with each other. Therefore, it was identified that liquid crystal molecules in the optical film were homeotropically aligned to the film plane of the optical film. In addition, defects such as blurs due to the alignment of the liquid crystals and the like were not observed from the optical film prepared in the present Example.

### Comparative Example 1

### Preparation of Optical Film

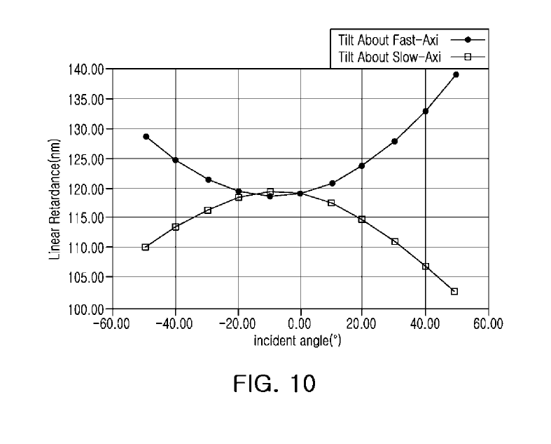

An optical film was obtained in the same manner as in Example 1, except that an amino-based coupling agent was not used in the alignment layer composition, and the alignment layer and liquid crystal layer produced were very transparent and had thicknesses of about 0.3 μm and about 1.2 μm, respectively. The alignment layer prepared in Comparative Example 1 had poor adhesive strength to the liquid crystal layer and the substrate, and thus some of the alignment layer was peeled off from the substrate and some of the liquid crystal was peeled off from the alignment layer. In addition, in order to investigate optical properties (alignment) of the optical films, the phase difference of the liquid crystal film adhered on the substrate was measured by using an AxoScan (manufactured by Axometrics, Inc.), and the result is shown in FIG. 10. It was determined from FIG. 10 that the liquid crystals were aligned to be slightly inclined due to defects such as blurs generated by the alignment of micro liquid crystals in the optical film in Comparative Example 1.

### Comparative Example 2

### Preparation of Optical Film

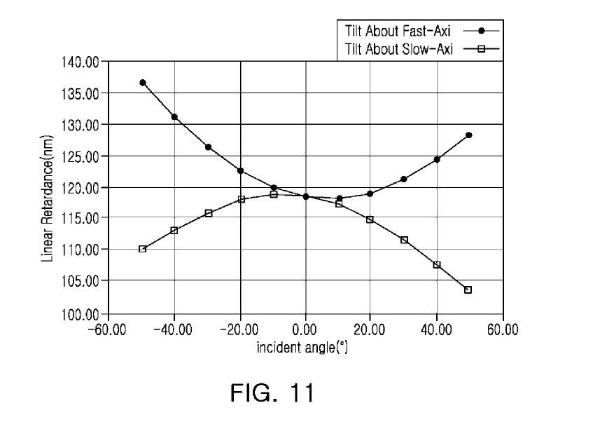

An optical film was obtained in the same manner as in Example 5, except that an amino-based coupling agent was not used in the alignment layer composition, and the alignment layer and liquid crystal layer produced were very transparent and had thicknesses of about 0.3 μm and about 1.2 μm, respectively. The alignment layer prepared in Comparative Example 2 had poor adhesive strength to the liquid crystal layer and the substrate, and thus some of the alignment layer was peeled off from the substrate and some of the liquid crystal was peeled off from the alignment layer. In addition, it is determined from the optical film in Comparative Example 2 that the liquid crystals were aligned to be slightly inclined due to defects such as blurs generated by the alignment of micro liquid crystals from a variation curve of phase difference values according to the view angle of the optical film shown in FIG. 11.

From samples of the optical films prepared in Examples 1 to 8 and Comparative Examples 1 and 2, the adhesive strengths and alignments were compared and summarized in the following Table 4.

TABLE 4

| | Alignment | Liquid | | |
|---|---|---|---|---|
| | layer | crystal | | |
| Sample | composition | solution | Adhesion | Alignment |
| Example 1 | Preparation | Preparation | Not peeled- | Homeotropic |
| | Example 1 | Example 1 | off | alignment |
| Example 2 | Preparation | Preparation | Not peeled- | Homeotropic |
| | Example 2 | Example 1 | off | alignment |
| Example 3 | Preparation | Preparation | Not peeled- | Homeotropic |
| | Example 3 | Example 1 | off | alignment |
| Example 4 | Preparation | Preparation | Not peeled- | Homeotropic |
| | Example 4 | Example 1 | off | alignment |
| Example 5 | Preparation | Preparation | Not peeled- | Homeotropic |
| | Example 5 | Example 2 | off | alignment |
| Example 6 | Preparation | Preparation | Not peeled- | Homeotropic |
| | Example 6 | Example 2 | off | alignment |
| Example 7 | Preparation | Preparation | Not peeled- | Homeotropic |
| | Example 7 | Example 2 | off | alignment |
| Example 8 | Preparation | Preparation | Not peeled- | Homeotropic |
| | Example 8 | Example 2 | off | alignment |
| Compara- | Excluding amino- | Preparation | Partially | Partially |
| tive | based coupling | Example 1 | peeled off | inclined |
| Example 1 | agent in the | | | alignment |
| | composition in | | | |
| | Preparation | | | |
| | Example 1 | | | |
| Compara- | Excluding amino- | Preparation | Partially | Partially |
| tive | based coupling | Example 2 | peeled off | inclined |
| Example 2 | agent in the | | | alignment |
| | composition in | | | |
| | Preparation | | | |
| | Example 1 | | | |

1. A liquid crystal alignment layer composition comprising:
1 wt % to 50 wt % of a photocurable resin binder;
0.01 wt % to 5 wt % of an amine compound selected from the group consisting of primary and secondary amino-based coupling agents;
0.1 wt % to 5 wt % of a photoinitiator; and
a remainder solvent.

2. The liquid crystal alignment composition of claim 1, wherein the photocurable resin binder is at least one selected from the group consisting of hydroxyethyl acrylate, hydroxypropyl acrylate, ethoxyethyl acrylate, ethyleneglycol dimethacrylate, diethyleneglycol dimethacrylate, polyethyleneglycol dimethacrylate, triethyleneglycol dimethacrylate, pentaerythritol acrylate, pentaerythritol diacrylate, pentaerythritol triacrylate, trimethylolpropane triacrylate, trimethylolpropane trimethaacrylate, dipentaacrythritol hexaacrylate, dipentaacrythritol pentaacrylate, dipentaerythritol tetraacrylate, dipentaerythritol pentaacrylate, a urethane acrylate oligomer, an epoxy acrylate oligomer, polyether acrylate, and polyester acrylate.

3. The liquid crystal alignment composition of claim 1, wherein the photoinitiator is at least one selected from the group consisting of 2-methyl-1-[4-(methylthio)phenyl]-2-(4-morpholinyl)-1-propanone, 2-dimethoxy-1,2-diphenylethan-1-one, 1-hydroxy-cyclohexyl-phenyl-ketone, triaryl sulfonium hexafluoroantimonate salts, and diphenyl(2,4,6-trimethylbenzoyl)-phosphine oxide.

4. The liquid crystal alignment composition of claim 1, wherein the primary amino-based coupling agent is represented by the following Formula 1.
R¹—R²—NH₂ [Formula 1]
where R¹ is selected from the group consisting of a C1-C20 alkyl group, C3-C6 cycloalkyl, a C1-C19 alkyl amine group, —NBB″, or —RSi(R′)ₙ(OR″)₃₋ₙ, B and B″ may be the same or different from each other and are independently selected from a group consisting of H and C1-C8 alkyl group, respectively, R, R′, and R″ may be the same or different one another and are independently selected from a C1-C8 alkyl group, respectively, n is an integer between 0 and 2, R² is a simple bond or a C1-C20 alkanediyl group and one or two —CH₂— groups that are not adjacent to each other in the alkanediyl group may be displaced with at least one group selected from the group consisting of an —O—, an —NH—, a —CH═CH—, a —CONH—, or a C3-C8 cycloalkanediyl group.

5. The liquid crystal alignment layer composition of claim 1, wherein the secondary amino-based coupling agent is represented by the following Formulas 2 to 5: 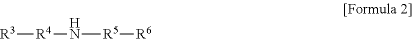
where R³ and R⁶ may be the same or different from each other and are independently selected from the group consisting of a C1-C20 alkyl group, a C1-C19 alkyl amine group, an amine group, or —RSi(R′)ₙ(OR″)₃₋ₙ, R, R′, and R″ may be the same or different from one another and are independently selected from a C1-C8 alkyl group, respectively, n is an integer between 0 and 2, R⁴ and R⁵ may be the same or different from each other and are independently selected from the group consisting of a simple bond and a C1-C20 alkanediyl group, and one or two —CH₂— groups that are not adjacent to each other in the alkanediyl group may be displaced with at least one group selected from the group consisting of an —O—, an —NH—, a —CH═CH—, a —CONH—, and a C3-C8 cycloalkanediyl group; 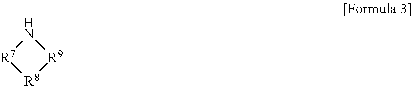
where R⁷, R⁸, and R⁹ may be the same or different from one another and are independently selected from a substituted or unsubstituted C1-C20 alkanediyl group, respectively, one or two —CH₂— groups that are not adjacent to each other in the alkanediyl group may be displaced with at least one group selected from the group consisting of an —O—, an —NH—, a —CH═CH—, a —CONH—, and a C3-C8 cycloalkanediyl group, and a substituent may be —C═O when the C1-C20 alkanediyl group is substituted; 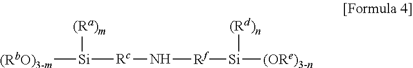
where R^{a}, R^{b}, R^{d}, and R^{e} may be the same or different from one another and are independently selected from a C1-C8 alkyl group, respectively, R^{e} and R^{f} may be the same or different from each other and are independently selected from a C1-C20 alkanediyl group, respectively, one or two —CH₂— groups that are not adjacent to each other in the alkanediyl group may be displaced with at least one group selected from the group consisting of an —O—, an —NH—, a —CH═CH—, a —CONH—, and a C3-C8 cycloalkanediyl group, and n and m are independently integers between 0 and 2, respectively; 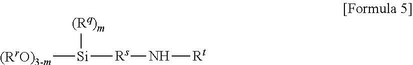
where R^{q}, R^{r}, and R^{t} may be the same or different from one another and are independently selected from a C1-C8 alkyl group, respectively, R^{s} is a C1-C20 alkanediyl group, one or two —CH₂— groups that are not adjacent to each other in the alkanediyl group may be displaced with at least one group selected from the group consisting of an —O—, an —NH—, a —CH═CH—, a —CONH—, or a C3-C8 cycloalkanediyl group, and m is an integer between 0 and 2.

6. The liquid crystal alignment composition of claim 1, wherein the primary amino-based coupling agent is at least one selected from the group consisting of methyl amine, ethyl amine, 1-propyl amine, 2-propyl amine, 1-butyl amine, 2-butyl amine and 3-(dimethylamino)propyl amine, cyclopropyl amine, cyclobutyl amine, cyclopentyl amine, and cyclohexyl amine.

7. The liquid crystal alignment composition of claim 1, wherein the secondary amino-based coupling agent is at least one selected from the group consisting of dimethyl amine, diethyl amine, dipropyl amine, dibutyl amine, azetidine, pyrrolidine, piperidine, 2-azetidinone, 2-pyrrolidinone, 2-piperidinone, bis(3-trimethoxy silylpropyl)amine, bis(3-triethoxy silylpropyl)amine, N-(n-butyl)-3-amino propyl trimethoxy silane, N-(n-butyl)-3-amino propyl triethoxy silane, N-methyl amino propyl trimethoxy silane, and N-methyl amino propyl triethoxy silane.

8. The liquid crystal alignment layer composition of claim 1, wherein the primary and secondary amino-based coupling agents are each at least one selected from the group consisting of amine compounds represented by the following Formulas 6-1 to 6-4.

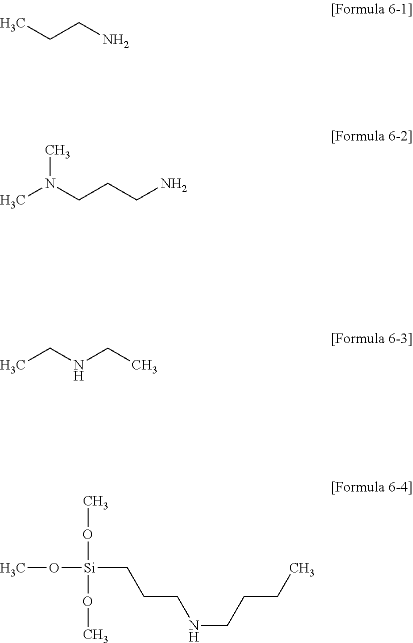

9. The liquid crystal alignment layer composition of claim 1, wherein the liquid crystals are homeotropically arranged.

10. A liquid crystal alignment layer formed of the liquid crystal alignment layer composition of claim 1.

11. A method for preparing a liquid crystal alignment layer comprising:
coating a substrate with the liquid crystal alignment layer composition of claim 1;
removing a solvent from the liquid crystal alignment layer composition; and
curing the liquid crystal alignment layer composition in which the solvent removed.

12. An optical film comprising:
a substrate;
an alignment layer formed of the liquid crystal alignment layer composition of claim 1 on the substrate; and
a liquid crystal layer formed on the alignment layer.

13. A display device comprising the optical film of claim 12.
